(19) United States
(12) Patent Application Publication
(10) Pub. No.: US 2010/0046773 A1
(43) Pub. Date: Feb. 25, 2010

(54) ACOUSTIC DEVICE AND METHOD OF MANUFACTURING THE SAME

(75) Inventors: Susanne Windischberger, Vienna (AT); Ewald Frasl, Biedermannsdorf (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/513,894

(22) PCT Filed: Oct. 16, 2007
(86) PCT No.: PCT/IB2007/054208

§ 371 Date: May 7, 2009

(30) Foreign Application Priority Data
Nov. 8, 2006 (EP) 06023219.6

(51) Int. Cl. H04R 25/00; H04R 31/00

(52) U.S. Cl. 381/164; 29/594

(57) ABSTRACT

An acoustic device (200, 300) comprising an oscillatory compound membrane (201) comprising a plurality of layers (202, 203, 205), wherein one of the plurality of layers (202, 203, 205) is a thermoplastic layer (203, 205), wherein the thermoplastic layer (203, 205) is joined to at least one further component (204, 206, 207) of the acoustic device (200).

### FIELD OF THE INVENTION

The invention relates to an acoustic device.

Moreover, the invention relates to a method of manufacturing an acoustic device.

### BACKGROUND OF THE INVENTION

Conventionally, a membrane, a coil and a cover of a loudspeaker or a microphone are joined to one another by means of a separate glue component. U.S. Pat. No. 6,915,555 discloses such a method of manufacturing a loudspeaker comprising continuously forming diaphragm portions and alignment portions on a band resin film, positioning one of a frame and a protector at an upper die or a lower die, aligning another alignment portion formed on the frame, the protector, the upper or lower die having the film disposed thereon with the alignment portion formed on the film, joining the frame and the resin film forming the diaphragm, and cutting a diaphragm out of the resin film.

According to another conventional technique, a diaphragm is joined by a support member using a polyvinylchloride copolymer rubber, i.e. a material adhering after vulcanization. U.S. Pat. No. 4,319,098 discloses such a loudspeaker. The periphery of the diaphragm of a loudspeaker is mechanically connected to a diaphragm support or basket by a layer of acoustic dampening-adhesive material. The layer of acoustic dampening-adhesive material covers a sufficient portion of the surfaces of the diaphragm to dampen standing waves which would otherwise reflect from the periphery of the diaphragm. Thus, a unitary diaphragm mechanical termination-acoustic termination structure is formed.

However, conventional acoustic devices suffer from a complex manufacturing process.

### OBJECT AND SUMMARY OF THE INVENTION

It is an object of the invention to provide an acoustic system which can be manufactured with reasonable effort.

In order to achieve the object defined above, an acoustic device is provided comprising an oscillatory compound membrane (or diaphragm) comprising a plurality of layers, wherein (at least) one of the plurality of layers is a thermoplastic layer, wherein (at least one of) the (at least one) thermoplastic layer is (directly) joined to at least one further component of the acoustic device.

In order to achieve the object defined above, furthermore a method of manufacturing an acoustic device is provided, wherein the method comprises the steps of providing an oscillatory compound membrane comprising a plurality of layers, wherein one of the plurality of layers is a thermoplastic layer, and joining the thermoplastic layer to at least one further component of the acoustic device.

The term “acoustic device” particularly denotes any apparatus which is capable of generating sound for emission to an environment and/or for the detection of sound present in the environment. Such an acoustic device may particularly include any electromechanical transducer capable of generating acoustic waves based on electric signals, or vice versa.

The term “oscillatory compound membrane” particularly denotes any multi-layer diaphragm which oscillates under the influence of a mechanical force and thereby generates sound. However, such an oscillatory compound membrane may also receive sound and convert it into mechanical oscillations for supply to a transducing element. Such a compound membrane can be formed of a plurality of different components and/or materials.

The term “thermoplastic” defines a material capable of softening when heated to change shape and capable of hardening when cooled to keep shape. This property may be maintained repeatedly, even after a plurality of heating/cooling cycles. Typical members of the thermoplastics family are styrene polymers and copolymers, acrylics, cellulosics, polyethylenes, vinyls, nylons, and the various fluorocarbon materials.

The term (thermoplastic) “layer” particularly denotes any physical structure (comprising a thermoplastic material) including a continuous uninterrupted two-dimensional area or a discontinuous structure like an annular structure or a structure comprising two or more non-connected portions.

The term “joint” particularly denotes any direct connection between two abutting members, without an intermediating separate component in between. It may characterize an adhering connection, a (physical or chemical) bonding, or any other permanent connection.

The term “thermal welding” particularly denotes a welding technique utilizing heating of one or both of the components to be joined, whereas a pressure is applied to the weld area or the two components are at least in contact. This joining method results in the surface molecules of the parts being joined to fuse together at the weld seam.

The term “at least one further component of the acoustic device” particularly denotes any element which forms, together with the oscillatory compound membrane, the acoustic device (for instance a loudspeaker or a microphone).

The term “acoustically damping” particularly denotes a material property which makes is possible to selectively damp acoustic waves. Particularly, such an acoustically damping member may dampen standing waves on a diaphragm. Usually, in an acoustic device, an acoustic ground mode is desirable to obtain a proper audio performance whereas higher modes may be disturbing and should therefore be suppressed by damping.

The term “electrodynamic acoustic device” particularly denotes an acoustic device which converts acoustic waves into electric signals, or vice versa, using an electromagnetic principle, for instance a coil and a magnet configuration.

The term “piezoelectric acoustic device” denotes an acoustic device which is based on the piezoelectric effect. For instance, such a device may be adapted as a piezoelectric microphone. A piezoelectric microphone uses the phenomenon of piezoelectricity—the tendency of some materials to produce an electric voltage when subjected to a mechanical pressure, or vice versa—to convert vibrations into an electrical signal. However, the device may also be adapted as a piezoelectric loudspeaker based on the phenomenon of piezoelectricity.

According to an embodiment of the invention, a thermoplastic layer or structure of a compound membrane is used for two purposes simultaneously, namely to mechanically connect the compound membrane to other parts of the acoustic device and to simultaneously serve as an acoustically damping material. For instance, a damping thermoplastic material of a membrane is directly glued to components of the electroacoustic transducer. By covering a membrane with a thermoplastic material serving for acoustically damping, the damping material may be synergetically used to fix the cover without additional glue. This is a significant improvement compared to conventional approaches, in which additional glue is needed and needs to be fixed to a cover of this membrane.

The bonding between the thermoplastic material of the membrane and the further component may be performed by locally melting the thermoplastic material at a predeterminable bonding position and by simply contacting the melted thermoplastic material with the further component. Particularly, this may be achieved by heating only the further component (for instance made from a metallic material) and by bringing the hot further component in contact with the cold thermoplastic material. This results in a melting of the thermoplastic material by heat conduction. After cooling the contacted members (actively by positioning the members in a cool environment or passively by simply waiting until the members are cooled down by thermal equilibration), they remain joined to one another.

In contrast to conventional non-thermoplastic rubber materials, which form networks and cannot be melted by heating, and thermosets like resins, which cannot be melted by heating as well, thermoplastic elastomers become liquid again after melting and become adhering, which makes these materials particularly appropriate for producing acoustic devices with low effort.

Thus, one aspect of the invention is related to the connection of compound membranes comprising a thermoplastic layer with other parts by means of thermo welding or any other tempering procedure. Therefore, an acoustic device (for instance a loudspeaker) is provided comprising a compound membrane having a thermoplastic layer (for instance exposed towards an environment) which has the effect of an acoustic damping (or oscillation damping) and which is connected with a further part of the loudspeaker by means of thermo welding.

In contrast to conventional approaches in which the membrane or diaphragm, the coil and the cover of a speaker/microphone are joined by means of a glue, embodiments of the invention use a compound membrane comprising two layers of material where one material is comparably rigid (for instance polycarbonate) and one for damping is soft(er) and itself may serve as some kind of glue. Taking this measure allows for a fast and cheap manufacturing process for speakers/microphones. Therefore, according to an embodiment, a loudspeaker with a diaphragm with at least two layers is provided, one layer being gluey, and an edge of the diaphragm being adhered directly to a cover, a coil and/or any other component of an acoustic device.

Further embodiments of the acoustic device will be explained hereinafter, which embodiments also apply to the method of manufacturing the acoustic device.

The thermoplastic layer may be joined to the at least one further component by tempering, particularly by thermal welding. In other words, by increasing the temperature, the thermoplastic layer is melted and is brought in an adhering state, thereby providing a very simple and effective method of connecting the thermoplastic layer directly to a further component of the acoustic device without the need of any intermediate material.

An externally exposed surface of the thermoplastic layer may be joined to the at least one further component. The term “externally exposed” denotes a surface of the thermoplastic layer which is directed to an environment, for instance a volume to which sound shall be emitted or from which sound shall be detected. Exposing the thermoplastic layer may allow to efficiently use the thermoplastic layer as an acoustic damping element and as a material being “thermally switchable” between an adhering and a non-adhering state.

The thermoplastic layer may be a structure covering only portions (essentially one-dimensional or two-dimensional portions) of the membrane, or may even cover the entire membrane. In the latter embodiment, the thermoplastic layer is a continuous layer without recesses. This allows for proper damping properties of the thermoplastic layers, double-functioning as a mechanical connection element and as an acoustical damping element.

The thermoplastic layer may be joined to the at least one further component without an additive, particularly without an additional adhesive. In other words, no further material is necessary to be provided between the thermoplastic layer and the further component of the acoustic device which is directly connected to the thermoplastic layer. This makes the manufacture easy, cheap and makes the acoustic device small and light in weight.

The at least one further component of the acoustic device may comprise at least one of the group consisting of a base member, a cover member, a transducing element, and a coil. A base member (or housing) may be a mechanical support on which different components of the acoustic device are mounted. A cover member may be an upper cap of the acoustic device. A transducer element may be an element converting between acoustic and electrical signals, for instance a coil in combination with a permanent magnet, or a piezoelectric element. A rim of the membrane may be connected to the base member and/or to the cover member. A more central portion of the two-dimensional membrane may be connected to the transducer element/coil/piezoelectric element. The direct connection of the membrane with one or more of these elements may allow for an efficient and reliable connection and simultaneously provides an acoustic device having a proper audio performance.

The thermoplastic layer may be joined to at least two further components of the acoustic device. By coupling the thermoplastic layer to a plurality of components of the acoustic device, the adhering and damping properties of the thermoplastic material are used in a very efficient manner.

The at least two further components of the acoustic device may particularly comprise the base member and the coil. Thus, one and the same thermoplastic layer may be connected to both the base member and the coil. This may be particularly advantageous due to the usual arrangement of base member, coil and membrane relative to one another (see, for instance, FIG. 3).

Three further components of the acoustic device to be connected to the membrane may be the base member and the coil and the cover member. In other words, these three (or even more) further components are connected to one and the same thermoplastic layer which results in a very economic configuration.

It is also possible that another one of the plurality of layers is a further thermoplastic layer opposing the thermoplastic layer, wherein the further thermoplastic layer may be joined to at least one further component of the acoustic device. Thus, both sides of the compound membrane may have an exposed surface portion formed by a thermoplastic material. This allows to glue both surfaces of the compound membrane to adjacent components.

The thermoplastic layer may be joined to the at least one further component by locally tempering selectively a bonding portion of the thermoplastic layer. For instance, the further component may be heated and may be contacted with the (cool) bonding portion of the thermoplastic layer to melt the latter. This allows to perform the bonding with low effort and low heat introduction.

The acoustic apparatus may be realized as at least one of the group consisting of a handheld sound reproduction system, a wearable device, a near-field sound reproduction system, headphones, earphones, a portable audio player, an audio surround system, a mobile phone, a headset, a hearing aid, a handsfree system, a television device, a TV set audio player, a video recorder, a monitor, a gaming device, a laptop, a DVD player, a CD player, a harddisk-based media player, an internet radio device, a public entertainment device, an MP3 player, a hi-fi system, a vehicle entertainment device, a car entertainment device, a medical communication system, a speech communication device, a home cinema system, a home theater system, a flat television apparatus, an ambiance creation device, and a music hall system.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 show a conventionally manufactured acoustic device.

FIG. 2 and FIG. 3 shows acoustic devices according to exemplary embodiments of

the invention.

### DESCRIPTION OF EMBODIMENTS

The illustration in the drawing is schematically. In different drawings, similar or identical elements are provided with the same reference signs.

Conventional acoustic transducers comprise a plurality of members which may be connected to one another by gluing. Due to the small dimension of acoustic transducers, many other fastening options result in an undesired mechanical load. Furthermore, in contrast to many other options a sufficient sealing can be achieved only by gluing.

However, conventional adhering processes using additional adhering materials require a high effort when manufacturing an acoustic device and are inaccurate, particularly for miniaturized members. Particularly, it can happen that the adhering material flows to undesired portions of the acoustic device. Furthermore, conventional adhering procedures require additional expensive process steps.

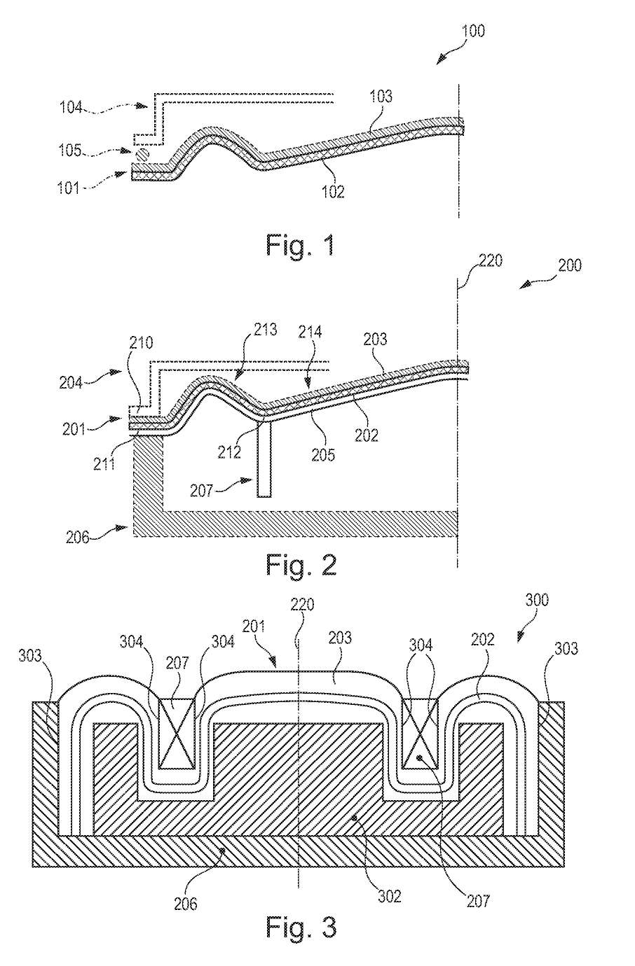

FIG. 1 shows a schematic cross-section through a part of an acoustic device 100 (like a loudspeaker) according to a conventional approach.

As it can be seen, a compound membrane 101 is provided having a base layer 102 and a damping layer 103 provided on the base layer 102. A cover member 104 is connected at the rim portion of the compound membrane 101 using an additional glue 105. The provision of the additional glue 105 makes the method inaccurate and expensive.

In contrast to conventional approaches and according to an embodiment of the invention, a damping layer of a multi-compound membrane is used for adhering the membrane to other components (for instance a cover of the transducer with the membrane, a coil with the membrane, etc.).

According to an embodiment of the invention, such a compound material comprises a plurality of layers which on the one hand determine the rigidness of the membrane and on the other hand influence the damping properties of the membrane. The damping layer may be realized as a glue material. By provision of the damping layer on such a side of the compound membrane to which also other components (for instance a cover element) are to be adhered, the damping layer can be used for adhering (instead of the conventional adhering procedure including an additional adhering material).

FIG. 2 shows an acoustic device 200, for instance a loudspeaker, according to an exemplary embodiment of the invention (as indicated by a symmetry line 220, FIG. 2 shows a cross section of essentially a half of the acoustic device 200).

The acoustic device 200 comprises an oscillatory compound membrane 201 comprising a plurality of layers. A first (central) layer 202 serves as an oscillatory base layer, and a second layer 203 provided on the base layer 202 is a thermoplastic layer. A third layer 205 provided beneath the base layer 202 is also a thermoplastic layer.

As it can be seen in the schematic illustration in FIG. 2, the thermoplastic layer 203 is joined to a cover element 204 of the acoustic device 200 in a joining region 210. The direct joint is generated by melting the thermoplastic layer 203 and by contacting the melted thermoplastic layer 203 with the (metallic) cover element 204. Thus, a separate adhering or gluing material 105 can be omitted.

The thermoplastic layer 203 may be joined to the cover element 204 by locally heating the thermoplastic layer 203 (for instance by contacting the thermoplastic layer 203 with a previously heated (for example metallic) cover element 204). Consequently, the material of the thermoplastic layer 203 is melted and becomes sticky so that the cover layer 204 can be fixed on the thermoplastic membrane 203 by simply contacting it with the thermoplastic layer 203 and cooling the entire arrangement down to a temperature at which the thermoplastic layer 203 is entirely solid.

The cover element 204 may be made of any appropriate material, like metal or plastics. The thermoplastic layer 203 may be made of polyurethane and may therefore serve for mechanically fastening the cover element 204 and simultaneously for damping acoustic waves.

As further shown in FIG. 2, the additional thermoplastic layer 205 is provided on a side of the base layer 202 opposing the thermoplastic layer 203. As indicated schematically in FIG. 2, the further thermoplastic layer 205 is connected to a base element 206 of the acoustic device 200 in a joining portion 211. The base element 206 (which is also referred to as a housing or a basket) may be made of any appropriate material, like metal or plastics, for instance polycarbonate.

A lower surface of the further thermoplastic layer 205 may also be connected to a coil 207 of an electrodynamic transducing element in a joining portion 212. This may be achieved by heating the (metallic) coil 207 and by pressing it against the (non-heated) further thermoplastic layer 205. By heat conduction, the further thermoplastic layer 205 is locally melted, and after cooling the coil 207, the coil 207 remains securely fastened to the further thermoplastic layer 205.

A (strongly curved) portion 213 of the membrane 201 on the left hand side of the coil 207 in FIG. 2 may be relatively flexible, whereas a portion 214 of the membrane 201 on the right hand side of the coil 207 in FIG. 2 may be relatively rigid.

FIG. 2 clearly shows that the damping layers 203, 205 of the compound membrane 201 are used for directly joining the membrane 201 to the speaker cover 204, to the speaker base 206 and to the coil 207.

Exemplary materials for the damping layers 203, 205 are polyurethane or other thermoplastic materials. By heating them, they may become soft and gluey.

FIG. 3 shows a loudspeaker 300 as an acoustic device according to a further embodiment of the invention.

The loudspeaker 300 comprises a compound membrane 201 formed by the first layer 202 and by the second layer 203. Layer 205 is omitted in the embodiment of FIG. 3.

Furthermore, FIG. 3 shows a housing or base member 206 and a magnetic arrangement 302. The magnetic arrangement 302 cooperates with a coil 207. When the coil 207 is activated by an electric audio signal, an electromagnetic force occurs between the coil 207 and the magnetic system 302. This forces the membrane 201 to be excited in accordance with the exciting acoustic signals, thereby generating acoustic waves which are emitted to an environment perceivable by a human listener.

A directly adhering connection between the second layer 203 of the compound membrane 201 and the base member 206 is denoted with reference numeral 303. A directly adhering connection between the second layer 203 of the compound membrane 201 and the coil 207 is denoted with reference numeral 304.

A portion of the compound membrane 201 being positioned inside of the annular coil 207 is relatively rigid. A portion of the compound membrane 201 being positioned close to vertical portions of the base member 206 is relatively flexible. The magnetic system 302 is not connected to the compound membrane 201, according to the embodiment of FIG. 3.

The first layer 202 is made of a rigid thermoplastic material and has a relatively high melting point. The second layer 203 is made of a softer thermoplastic material and has a lower melting point (for instance between essentially 150° C. and essentially 200° C.). Together, the first layer 202 and the second layer 203 form the compound membrane 201 which may function, when implemented in a loudspeaker, as a sealing member, and a damping element selectively damping defined acoustic modes. As the first layer 202 is comparatively rigid, it mainly contributes to the bending properties and ensures that the membrane 201 keeps its shape. As the second layer 203 is comparatively soft, it mainly contributes to the damping properties of the compound membrane 201.

As an alternative to the loudspeaker 300, the compound membrane 201 may also be implemented in a microphone, or any other acoustic device.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. Use of the verb “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. An acoustic device, comprising:
an oscillatory compound membrane that includes a plurality of layers, wherein one of the plurality of layers is a thermoplastic layer, and and
at least one further component of the acoustic device,
wherein the thermoplastic layer is joined to the at least one further component of the acoustic device.

2. The acoustic device according to claim 1, wherein the thermoplastic layer is joined to the at least one further component by tempering.

3. The acoustic device according to claim 1, wherein an externally exposed surface of the thermoplastic layer is joined to the at least one further component.

4. The acoustic device according to claim 1, wherein the thermoplastic layer is an acoustically damping layer.

5. The acoustic device according to claim 1, wherein the thermoplastic layer is joined to the at least one further component without an additive.

6. The acoustic device according to claim 1, wherein the at least one further component of the acoustic device comprises at least one of the group comprising a base member, a cover member, a transducer element, and a coil.

7. The acoustic device according to claim 1, wherein a second of the plurality of layers is a thermoplastic layer that opposes the one of the plurality of layers, wherein the second of the plurality of layers is joined to the at least one further component of the acoustic device.

8. The acoustic device according to claim 1, wherein the acoustic device is an electrodynamic acoustic device or a piezoelectric acoustic device.

9. The acoustic device according to claim 1, wherein the acoustic device is a speaker, a microphone, a receiver, or a vibrator.

10. The acoustic device according to claim 1, wherein the acoustic device is a handheld sound reproduction system, a wearable device, a near-field sound reproduction system, headphones, earphones, a portable audio player, an audio surround system, a mobile phone, a headset, a hearing aid, a handsfree system, a television device, a TV set audio player, a video recorder, a monitor, a gaming device, a laptop, a DVD player, a CD player, a hard_disk-based media player, an internet radio device, a public entertainment device, an MP3 player, a hi-fi system, a vehicle entertainment device, a car entertainment device, a medical communication system, a speech communication device, a home cinema system, a home theater system, a flat television apparatus, an ambiance creation device, or a music hall system.

11. A method of manufacturing an acoustic device, the method comprising
forming an oscillatory compound membrane that includes a plurality of layers, wherein one of the plurality of layers is a thermoplastic layer; and
joining the thermoplastic layer to at least one further component of the acoustic device.

12. The method according to claim 11, wherein the joining step comprises joining an externally exposed surface of the thermoplastic layer to the at least one further component, wherein the thermoplastic layer is an acoustically damping layer.

13. The method according to claim 12, further comprising joining a second of the plurality of layers to the at least one further component of the acoustic device, wherein the second of the plurality of layers is a thermoplastic layer that opposes the one of the plurality of layers.
